(19) United States
(12) Patent Application Publication
(10) Pub. No.: US 2019/0129062 A1
(43) Pub. Date: May 2, 2019

(54) ENVIRONMENTAL IMPACT MONITORING FOR DOWNHOLE SYSTEMS

(71) Applicants: Manuel Peter Hoegerl, Al-Khobar (SA); Abdulaziz Abdulrhman Almathami, Al-Khobar (SA)

(72) Inventors: Manuel Peter Hoegerl, Al-Khobar (SA); Abdulaziz Abdulrhman Almathami, Al-Khobar (SA)

(73) Assignee: Baker Hughes, a GE company, LLC, Houston, TX (US)

(21) Appl. No.: 15/795,854

(22) Filed: Oct. 27, 2017

(51) Int. Cl. G01V 8/16; G01D 5/353; G01N 17/04; E21B 47/12; E21B 47/00

(52) U.S. Cl. CPC G01V 8/16; G01D 5/353; E21B 47/00; E21B 47/123; G01N 17/04

(57) ABSTRACT

Optical fiber sensor systems for monitoring environmental impacts in downhole systems are provided. The optical fiber sensor systems include an optical fiber arranged along a downhole tool, the optical fiber having a first end and a second end, a light source coupled to the first end of the optical fiber and configured to project light into and along the optical fiber, a photodetector coupled to the first end of the optical fiber and configured to monitor light reflected along and through the optical fiber, and at least one sensing element arranged on the optical fiber, the at least one sensing element arranged to change a light property of the optical fiber, wherein a change in the light property of the optical fiber occurs based on exposure of the at least one sensing element to an environment of a region of interest.

### BACKGROUND

### 1. Field of the Invention

The present invention generally relates to downhole components and sensors for indirectly monitoring or inferring environmental impact and damage to downhole components.

### 2. Description of the Related Art

Boreholes are drilled deep into the earth for many applications such as carbon dioxide sequestration, geothermal production, and hydrocarbon exploration and production. In all of the applications, the boreholes are drilled such that they pass through or allow access to a material (e.g., a gas or fluid) contained in a formation located below the earth's surface. Different types of tools and instruments may be disposed in the boreholes to perform various tasks and measurements, during both drilling and subsequent production operations (downhole operations).

During downhole operations, the downhole components may be subject to corrosion and various chemicals or environments that can cause wear, fatigue, and/or failure of such components. This may be prevalent, for example, during production operations where downhole components are exposed to corrosive environments. Thus it is advantageous to provide monitoring of such downhole components to determine if the components are approaching a critical amount of wear.

### SUMMARY

Disclosed herein are systems and methods for optical fiber sensing systems for monitoring environmental impacts in downhole systems are provided. The optical fiber sensor systems include an optical fiber arranged along a downhole tool, the optical fiber having a first end and a second end, a light source coupled to the first end of the optical fiber and configured to project light into and along the optical fiber, a photodetector coupled to the first end of the optical fiber and configured to monitor light reflected along and through the optical fiber, and at least one sensing element arranged on the optical fiber, the at least one sensing element arranged to change a light property of the optical fiber, wherein a change in the light property of the optical fiber occurs based on exposure of the at least one sensing element to an environment of a region of interest.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 depicts a system for formation stimulation and hydrocarbon production that can incorporate embodiments of the present disclosure;

FIG. 2 is an example of a system for performing downhole operations that can employ embodiments of the present disclosure;

FIG. 3A is a schematic illustration of an optical fiber sensor system in accordance with an embodiment of the present disclosure;

FIG. 3B is a detailed illustration of a portion of the optical fiber sensor system of FIG. 3A;

FIG. 4 is a schematic illustration of a portion of an optical fiber sensor system in accordance with an embodiment of the present disclosure;

FIG. 5 is a schematic illustration of a portion of an optical fiber sensor system in accordance with an embodiment of the present disclosure;

FIG. 6 is a schematic illustration of a portion of an optical fiber sensor system in accordance with an embodiment of the present disclosure;

FIG. 7 is a schematic illustration of a portion of an optical fiber sensor system in accordance with an embodiment of the present disclosure;

FIG. 8 is a schematic illustration of a portion of an optical fiber sensor system in accordance with an embodiment of the present disclosure;

FIG. 9 is a schematic illustration of a portion of an optical fiber sensor system in accordance with an embodiment of the present disclosure;

FIG. 10 is a schematic illustration of a portion of an optical fiber sensor system in accordance with an embodiment of the present disclosure;

FIG. 11 is a schematic illustration of a portion of an optical fiber sensor system in accordance with an embodiment of the present disclosure;

FIG. 12 is a schematic illustration of a system having an optical fiber sensor system for monitoring downhole environments and/or corrosion in accordance with an embodiment of the present disclosure;

FIG. 13 is a schematic illustration of a system having an optical fiber sensor system for monitoring downhole environments and/or corrosion in accordance with an embodiment of the present disclosure;

FIG. 14A is a schematic illustration of how a sensing element can alter a light property of a fiber optic cable in accordance with an embodiment of the present disclosure;

FIG. 14B illustrates a change a light property of a fiber optic cable after the sensing element has been exposed to one or more corrosive environments;

FIG. 15A is a schematic illustration of how a sensing element can alter a light property of a fiber optic cable in accordance with an embodiment of the present disclosure; and

FIG. 15B illustrates a change in a light property of a fiber optic cable after the sensing element has been exposed to one or more corrosive environments.

### DETAILED DESCRIPTION

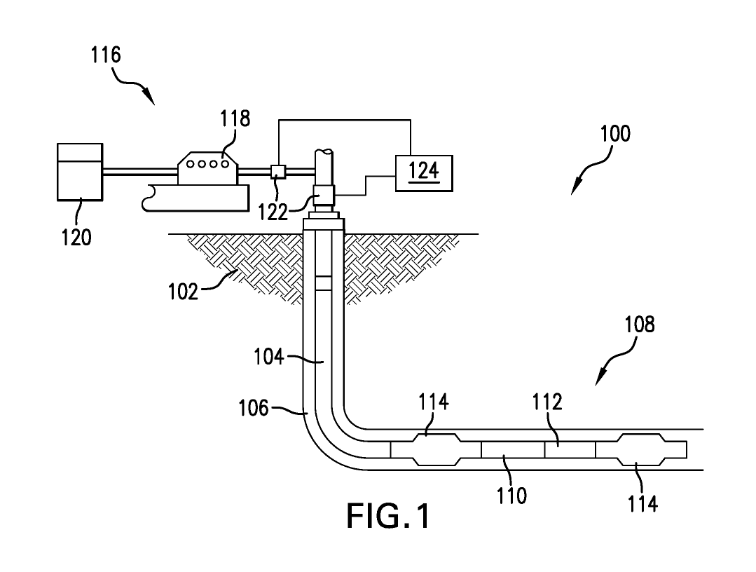

Referring to FIG. 1, a schematic illustration of an embodiment of a system 100 for hydrocarbon production and/or evaluation of an earth formation 102 that can employ embodiments of the present disclosure is shown. The system 100 can be any type of production system and associated environment. For example, the system 100 can be used for the production of oil, gas, water and/or can be an injector well system.

The system 100 includes a borehole string 104 disposed within a borehole 106. The string 104, in one embodiment, includes a plurality of string segments or, in other embodiments, is a continuous conduit such as a coiled tube. As described herein, “string” refers to any structure or carrier suitable for lowering a tool or other component through a borehole or connecting a drill bit to the surface, and is not limited to the structure and configuration described herein. The term “carrier” as used herein means any device, device component, combination of devices, media, and/or member that may be used to convey, house, support, or otherwise facilitate the use of another device, device component, combination of devices, media, and/or member. Example, non-limiting carriers include, but are not limited to, casing pipes, wirelines, wireline sondes, slickline sondes, drop shots, downhole subs, bottomhole assemblies, and drill strings.

In one embodiment, the system 100 is configured as a hydraulic stimulation system. As described herein, “stimulation” may include any injection of a fluid into a formation. A fluid may be any flowable substance such as a liquid or a gas, or a flowable solid such as sand. In such embodiment, the string 104 includes a downhole assembly 108 that includes one or more tools or components to facilitate stimulation of the formation 102. For example, the string 104 includes a fluid assembly 110, such as a fracture or “frac” sleeve device or an electrical submersible pumping system, and a perforation assembly 112. Examples of the perforation assembly 112 include shaped charges, torches, projectiles, and other devices for perforating a borehole wall and/or casing. The string 104 may also include additional components, such as one or more isolation or packer subs 114.

One or more of the downhole assembly 108, the fracturing assembly 110, the perforation assembly 112, and/or the packer subs 114 may include suitable electronics or processors configured to communicate with a surface processing unit and/or control the respective tool or assembly.

A surface system 116 can be provided to extract material (e.g., fluids) from the formation 102 or to inject fluids through the string 104 into the formation 102 for the purpose of fraccing.

As shown, the surface system 116 includes a pumping device 118 in fluid communication with a tank 120. In some embodiments, the pumping device 118 can be used to extract fluid, such as hydrocarbons, from the formation 102, and store the extracted fluid in the tank 120. In other embodiments, the pumping device 118 can be configured to inject fluid from the tank 120 into the string 104 to introduce fluid into the formation 102, for example, to stimulate and/or fracture the formation 102.

One or more flow rate and/or pressure sensors 122, as shown, are disposed in fluid communication with the pumping device 118 and the string 104 for measurement of fluid characteristics. The sensors 122 may be positioned at any suitable location, such as proximate to (e.g., at the discharge output) or within the pumping device 118, at or near a wellhead, or at any other location along the string 104 and/or within the borehole 106.

A processing and/or control unit 124 is disposed in operable communication with the sensors 122, the pumping device 118, and/or components of the downhole assembly 108. The processing and/or control unit 124 is configured to, for example, receive, store, and/or transmit data generated from the sensors 122 and/or the pumping device 118, and includes processing components configured to analyze data from the pumping device 118 and the sensors 122, provide alerts to the pumping device 118 or other control unit and/or control operational parameters, and/or communicate with and/or control components of the downhole assembly 108. The processing and/or control unit 124 includes any number of suitable components, such as processors, memory, communication devices and power sources.

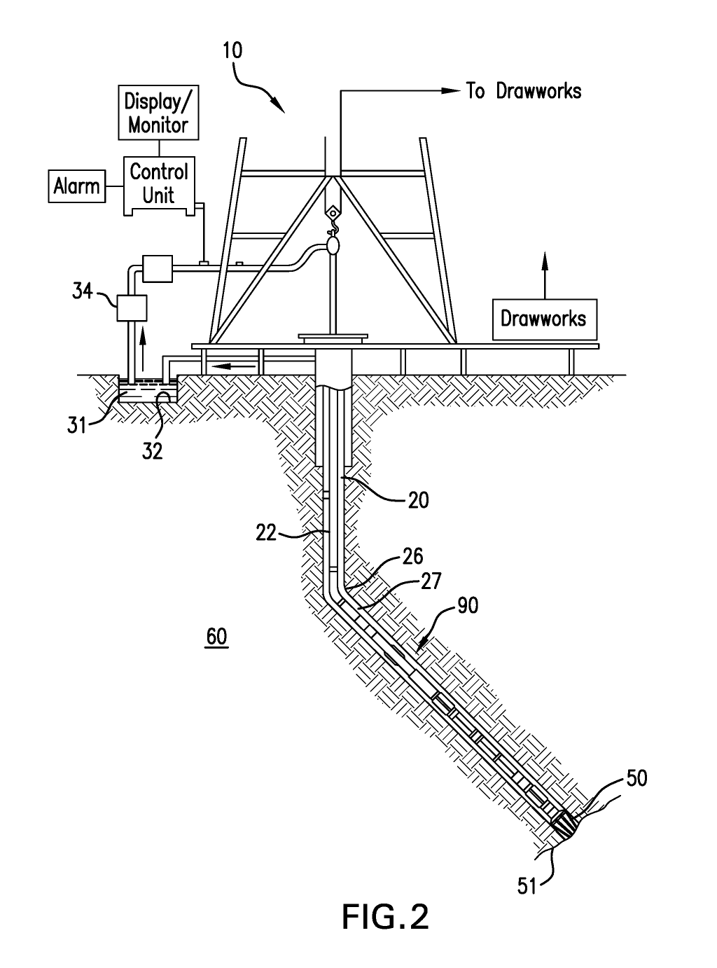

FIG. 2 shows a schematic diagram of a system 10 for performing downhole operations. As shown, the system is a drilling system 10 that includes a drill string 20 having a bottomhole assembly 90 (BHA 90) that is conveyed in a borehole 26 penetrating an earth formation 60. The drill string 20 includes a drilling tubular 22, such as a drill pipe, extending downward from the rotary table 14 into the borehole 26. A disintegrating tool 50, such as a drill bit attached to the end of the BHA 90, disintegrates the geological formations when it is rotated to drill the borehole 26. The drill string 20 is coupled to surface equipment such as systems for lifting, rotating, and/or pushing, as will be appreciated by those of skill in the art.

During drilling operations a suitable drilling fluid 31 (also referred to as the “mud”) from a source or mud pit 32 is circulated under pressure through the drill string 20 by a mud pump 34. The drilling fluid 31 passes into the drill string 20 and is discharged at the borehole bottom 51 through an opening in the disintegrating tool 50. The drilling fluid 31 circulates uphole through the annular space 27 between the drill string 20 and the borehole 26 and returns to the mud pit 32 via a return line. The system may further include one or more downhole sensors 70 located on the drill string 20 and/or the BHA 90. The BHA 90 can include sensors, devices, or tools for providing a variety of measurements relating to the formation surrounding the borehole and for drilling the borehole 26 along a desired path.

Although FIG. 2 is shown and described with respect to a drilling operation, those of skill in the art will appreciate that similar configurations, albeit with different components, can be used for performing different downhole operations. For example, wireline, coiled tubing, and/or other configurations can be used as known in the art. Further, production configurations can be employed for extracting and/or injecting materials from/into earth formations. Thus, the present disclosure is not to be limited to drilling operations but can be employed for any appropriate or desired downhole operation(s).

Embodiments, provided herein are directed to in-situ real-time monitoring of corrosion processes and/or chemical environment impacts through the use of nano-materials, metals, and/or oxides to coat fiber optics to provide subsurface intelligence, e.g., information regarding corrosion processes and/or chemical environments. In accordance with some embodiments, an optical fiber is coated, equipped, or otherwise modified to include n-repetitive sensing elements selected from different materials. The material of the sensing elements is selected as sensitive to certain chemicals or the sensing elements may comprise a coating of the optical fiber that forms a sacrificial sensing element (e.g., removable or breakable coupon). The material or structure of the sensing elements are selected to react with a chemical species expected to be encountered in a downhole environment. For example, in some embodiments, the sensing elements may be formed from nano-structured material formed of a material formulated to react with at least one material selected from the group consisting of CO₂, H₂S, chloride ions, iron ions, calcium ions, magnesium ions, chromium ions, manganese ions, hydroxyl ions, and hydronium ions. Such modified optical fibers can be used during production operations, i.e. down hole or flow lines, however other applications are feasible, including, but not limited to drilling operations, exploration operations, or other industrial operations.

During downhole operations, such as production operations, understanding sources of corrosion is important to enable the development of targeted mitigation programs. As appreciated by those of skill in the art, corrosion is a complex interaction of many physical and chemical processes. Embodiments provided herein enable sensing of multiple chemical variables, physical variables, and corrosion variables to enable an improved picture of chemical processes underlying the corrosion processes that occur downhole.

In accordance with non-limiting embodiments of the present disclosure, multivariable sensors and/or sensor arrays are provided for application in harsh environments. Various types of corrosion (e.g., general, localized, pitting, environmental stress) are caused via several different mechanisms given the nature of the substrate (i.e., the material/structure of the sensing elements) and the surrounding environment. Embodiments provided herein enable concurrently sensing the effect of corrosion and the environmental conditions causing such corrosion (in comparison to typical systems that measure only one or the other of these characteristics).

The material of the sensing elements of the present disclosure can be any material formulated to interact with a chemical species, such that a concentration of the chemical species may be inferred based on analysis (either in situ or at a later time) of the sensing element (or a change in light properties of a fiber optic cable to which the sensing element is applied). For example, the sensing elements may be configured to interact with CO₂, H₂S, chloride ions, iron ions, calcium ions, magnesium ions, chromium ions, manganese ions, hydroxyl ions or hydronium ions (i.e., to measure pH), etc. The sensing elements may include nano-structured material(s) (e.g., nanoparticles, etc.), such as in a coating over the fiber optic cable. Nano-structured materials may be useful as chemical detectors because they may be more selective toward a chemical species than, for example, continuous generally planar surfaces of the same material. Thus, a sensing element containing nano-structured material may have a lower detection limit, may be more sensitive to relatively lower concentrations of a chemical species, and may yield results having a higher signal-to-noise ratio. In some embodiments, the sensing elements may include generally planar surfaces of material, such as metals, metal oxides, etc.

To enable broad scope and information, sensing elements of the present disclosure are applied to fiber optic cables, with the sensing elements having varied materials, configurations, etc., with each sensing element arranged to target a different variable. Such monitored downhole variables includes both corrosion phenomena and environmental variables (e.g., concentrations of H₂S, CO₂, pH, Cl, p,T). Accordingly, broad scopes of information from directed or specific sensing elements are provided, as opposed to ‘universal’ corrosion probes that are typically employed. In embodiments provided herein, combinations of varied materials, each optimized for sensing one downhole environmental/corrosion variable, provides more accurate information. Accordingly, advantageously, concurrent measurement of multiple environmental/corrosion variables provides detailed information and a high degree of accuracy.

In accordance with some embodiments, concurrent use of sensing elements having specific materials can be deployed downhole at the target locations for finite periods of time. Different applications and/or desired monitoring can require a selection of materials suitable for the targeted application and appropriate environmental shielding/packaging that enables an active (interactive) sensing element to be useable. In accordance with some embodiments, the sensitivity of the sensing elements (and particularly the material thereof) can be enhanced by using known techniques of surface area enhancement such as nano architectures, creating hollow cavities, spherical micro-balls. Such modifications can lead to improved data collection efficiencies.

Individual sensing elements of the present disclosure can be arranged as threshold sensing elements that are triggered when a threshold property exists, or may be continuous sensing elements that persistently monitor environmental/corrosion of a system. In some embodiments, the multipurpose sensing systems can be retrieved from downhole, analyzed, and compared to virgin state to obtain corrosion rates, concentration levels of environmental variables, etc. In some non-limiting embodiments, the sensing elements described herein can be constructed with an energy source and/or electronics interface, processor, memory, etc. to interrogate the material of the sensing elements and store or directly communicate readings.

Although described particularly herein as sub-surface monitoring in oil-and-gas exploration/production, embodiments of the present disclosure are not to be so limited. For example, sensing elements described herein can be used during drilling operations, exploration operations, used in mines, or at the surface. Furthermore, sensing elements (and systems incorporating such sensing elements) can be employed in various testing industries, such as vehicle testing in accelerated conditions, or in downstream refineries.

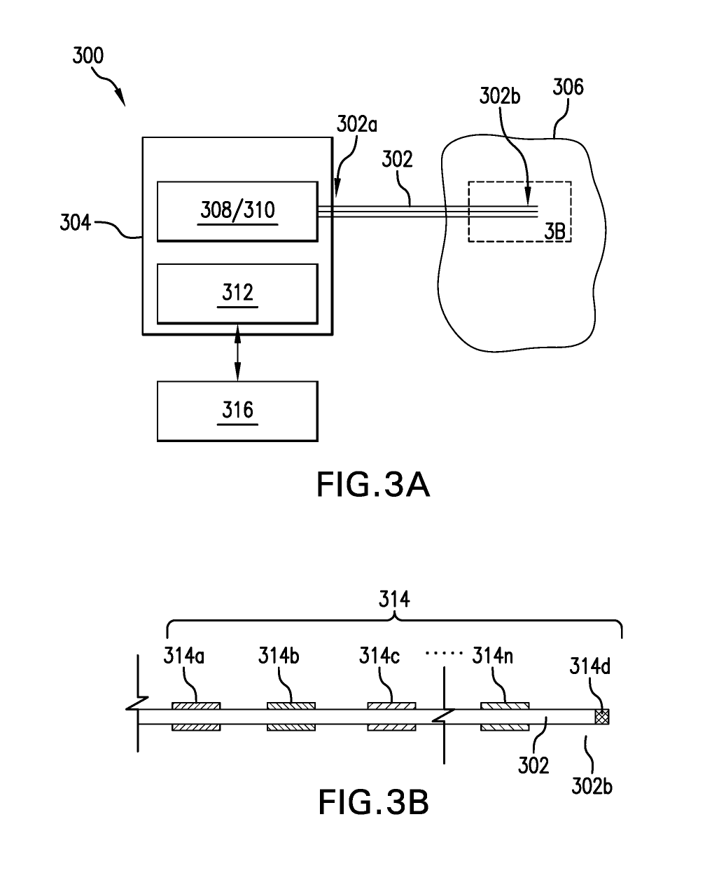

Turning now to FIGS. 3A-3B, schematic illustrations of an optical fiber sensor system 300 in accordance with an embodiment of the present disclosure are shown. The optical fiber sensor system 300 is arranged to provide monitoring of various chemical and/or environmental characteristics, properties, and/or impacts, such as corrosion, that may be present in downhole formations and/or boreholes and that may affect or impact downhole system operations and/or to allow corrections or other decisions to be made. The optical fiber sensor system 300 includes a fiber optic cable 302 that has a control system 304 positioned at a first end 302a of the fiber optic cable 302 and is disposed downhole with a second end 302b being located in a region of interest 306, such as within a borehole passing through a downhole formation. The region of interest 306 can be any relevant environment of interest, such as boreholes, pipelines, storage tanks, etc. The fiber optic cable 302 can be, for example, a single fiber, a fiber bundle, a collection of bundles, and thus the illustration is not to be limiting.

The control system 304, as shown, includes a light source 308, a photodetector 310, and a control element 312. The light source 308 and the photodetector 310 can be a single unit or may be arranged as separate unites or elements. The light source 308 is controllable by the control element 312 to interrogate the fiber optic cable 302 with light (e.g., transmit light into the fiber optic cable 302). The photodetector 310 is arranged to receive light signals reflected through the fiber optic cable 302. For example, the photodetector 310 can be arranged to receive light that travels from the first end 302a to the second end 302b of the fiber optic cable 302 and enable detection and subsequent analysis of the received signal(s).

As noted, the second end 302b of the fiber optic cable 302 is located in a region of interest 306, such as a downhole formation. The region of interest 306 can include one or more different environments that are desired to be monitored for corrosion and/or other chemical properties and/or environmental impacts. The control element 312 can be arranged to process the light that interacts with the fiber optic cable 302 to determine characteristics of the region of interest 306.

As shown in FIG. 3B, an enlarged illustration of a portion of the fiber optic cable 302 in accordance with an embodiment of the present disclosure is shown. The fiber optic cable 302 includes one or more sensing elements 314 (e.g., segments of material, coatings, etc.) installed thereon. The sensing elements 314 can be coatings, metallic sleeves, nano-material coatings or sleeve, etc. The sensing elements 314 can be located at one or more positions along the length of the fiber optic cable 302 and are not necessarily located proximate the second end 302b of the fiber optic cable 302, as illustratively shown. In this illustration, the sensing elements 314 include n-sensing elements 314a, 314b, 314c . . . 314n. The sensing elements 314 can be installed at different positions along the fiber optic cable 302, located on different fibers of a bundle of optical fibers, may be stacked at a single location, or combinations thereof

The sensing elements 314 can enable real-time, in-situ monitoring of corrosion and chemical environments that can cause corrosion or other impact upon component life, and thus provide subsurface (e.g., downhole) information. As shown, the fiber optic cable 302 includes the plurality of sensing elements 314a, 314b, 314c . . . 314n. Each sensing element 314a, 314b, 314c . . . 314n can be configured to be sensitive or reactive to certain chemicals. For example, a first sensing element 314a can be sensitive or reactive to a first chemical Cₐ, a second sensing element 314b can be sensitive or reactive to a second chemical C_{b}, a third sensing element 314c can be sensitive or reactive to a third chemical C_{c}, a fourth sensing element 314d can be sensitive or reactive to a fourth chemical C_{d}, and an n-th sensing element 314n can be sensitive or reactive to an n-th chemical Cₙ. The sensing elements 314 can be coatings or sacrificial elements that when exposed to the respective chemical can react in a manner that changes or alters a light property of the optic fiber cable 302.

The sensitivity and/or detection of chemicals, corrosion, and/or other characteristics, properties, and/or impacts of the region of interest 306 can be based on the arrangement and/or properties of the sensing elements 314. For example, the number of sensing elements installed on a given fiber optic cable (or optical fiber) can be selected for various detections. In one example, a first optical fiber of a bundle can have three sensing elements and another optical fiber in the same bundle can have five sensing elements. The difference in number of sensing elements can be used to infer different levels of corrosion or exposure to different amounts of a given chemical. In other embodiments, or in combination therewith, different materials can be selected for the different sensing elements 314, wherein the first sensing element 314a is composed of a first material and the n-th sensing element 314n is composed of an n-th material. Other variables associated with the sensing elements 314 can include, but are not limited to, thickness, axial length along the fiber optic cable, layering of multiple sensing elements, and the number of optical fibers to which a given sensing element 314 is applied. In some embodiments, the sensing elements 314 can be side-on coatings or sleeves (e.g., sensing elements 314a, 314b, 314c) or the sensing elements 314 can be end-on coatings or structures (e.g., sensing element 314d). For example, the axial length of the sensing element can be selected to achieve a desired change or alteration of light properties of the fiber optic cable.

As noted, the sensing elements 314 are reactive to chemicals, corrosion, or other characteristics/properties of the region of interest 306. As the light source 308 sends light into the fiber optic cable 302, the light will interact with portions of the fiber optic cable 302 that includes one or more of the sensing elements 314. The interaction between the light and the sensing elements 314 and/or between the light and portions of the fiber optic cable 302 where a sensing element 314 has been removed can be detected by the photodetector 310. The control element 312 can then analyze one or more data streams or signals from the photodetector 310 to make observations regarding the region of interest 306. In some embodiments, the control element 312 can be in operable communication with one or more remote systems 316. The communication can be through the internet, through wired connections, through local wired connections, or other connections and/or communication mechanisms as will be appreciated by those of skill in the art. Accordingly, in accordance with some embodiments, the optical fiber sensor system 300 can provide online monitoring of chemical environments (e.g., regions of interest 306). Further, advantageously, embodiments of the present disclosure can provide for single- or multi-point detection and/or monitoring.

The sensing elements of the present disclosure can have various characteristics and/or be arranged to specifically identify corrosion and/or chemical interaction associated with specific desired materials/chemicals. For example, sacrificial corrosion can be employed for various sensing elements. In such embodiments, for example, a carbon steel film and/or a Zinc Oxide nanosheet can be applied to a portion of an optical fiber. As apparent from the type of sensing element, these sensing elements are sacrificial and will erode or corrode due to exposure to certain chemicals. When the sacrificial sensing element is undamaged, a specific light signal will be received at a photodetector, whereas, once the sacrificial sensing element is damaged or completely removed, the light signal received at the photodetector will be different, which is thus detectable to determine corrosion at the location of the sensing element.

In other embodiments, different materials can be used in the form of films, nano-sheets, powders, coatings, pastes, paints, sleeves, etc. that are applied to an exterior surface of an optical fiber. Materials that can be selected for making sensing elements of the present disclosure can include, but are not limited to, metals and metal alloys such as iron, stainless steel, elemental metal/metal oxides, metal oxides such as zinc oxides, copper oxides, tungsten oxides, indium oxides, mixed metal/metal oxides such as barium titanate, stannate, metal carbonates, carbonates, silicates, aluminates, sulfides, calcium titanium oxides, metal silicates, metal aluminates, ion selective electrodes such as chalcogenite glasses, diamond (micro/nano diamond compounded with suitable binder), doped diamonds such as boron doped diamonds, organic-inorganic composite materials, nano-materials, etc. In some embodiments, combinations or configurations of sensing elements can be optimized to achieve specific desired interactions with chemicals, corrosion, and/or environments. For example, nano-structured materials can be selected with optimized material properties, such as sensitivity and/or selectivity to a particular chemical or chemical species, resistivity to other species, etc. That is, techniques may be employed to structure the material of the sensing elements at the nano-level (e.g., so called “nano-materials”) to achieve desired interactions and/or responses to chemicals, environments, and/or corrosion.

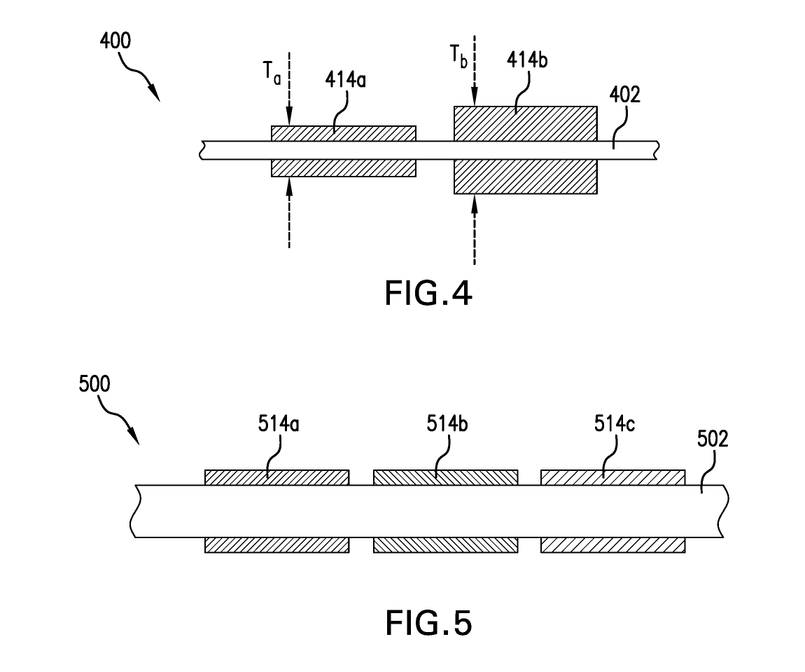

Turning now to FIG. 4, a schematic illustration of a portion of an optical fiber sensor system 400 in accordance with an embodiment of the present disclosure is shown. The optical fiber sensor system 400 can include a control system (not shown) similar to that shown and described above. FIG. 4 illustrates a fiber optic cable 402 having a first sensing element 414a and a second sensing element 414b disposed thereon. The first and second sensing elements 414a, 414b of this embodiment are formed from the same material. However, the first sensing element 414a has a first thickness Ta and the second sensing element 414b has a second thickness Tb that is greater than the first thickness Tₐ. This arrangement can provide for a corrosion lifetime sensing capability. In this arrangement, the different sensing elements 414a, 414b can erode or corrode at similar rates when exposed to a corrosive material that is corrosive to the material of the first and second sensing elements 414a, 414b. Although shown with two sensing elements, those of skill in the art will appreciate that any number (two or more) of sensing elements, with each having different thicknesses (or groups of sensing elements having different thicknesses) can be employed without departing from the scope of the present disclosure. The different thicknesses can enable the sensing elements 414a, 414b to have different corrosion rates and/or respond to different corrosion rates. Such different responses can extend the lifetime of the optical fiber sensor system 400. Moreover, a design can provide improved analysis (e.g., improved precision).

Turning now to FIG. 5, a schematic illustration of a portion of an optical fiber sensor system 500 in accordance with an embodiment of the present disclosure is shown. The optical fiber sensor system 500 can include a control system (not shown) similar to that shown and described above. FIG. 5 illustrates a fiber optic cable 502 having a first sensing element 514a, a second sensing element 514b, and a third sensing element 514c disposed at different axial positions along the fiber optic cable 502. The first, second, and third sensing elements 514a, 514b, 514c of this embodiment are each formed from different materials. For example, the first sensing element 514a is formed from a first material Mₐ, the second sensing element 514b is formed from a second material M_{b}, and the third sensing element 514c is formed from a third material M_{c}. The materials Mₐ, M_{b}, M_{c} are selected to corrode at different rates from each other. For example, the first material Ma can be selected to corrode at 0.5 Mils per year (mpy), the second material M_{b} can be selected to corrode at 10 mpy, and the third material can be selected to corrode at 50 mpy. As such, each sensing element 514a, 514b, 514c, having a given material, corresponds to a specific (and different) corrosion lifetime (i.e., a certain standard set of given environmental parameters).

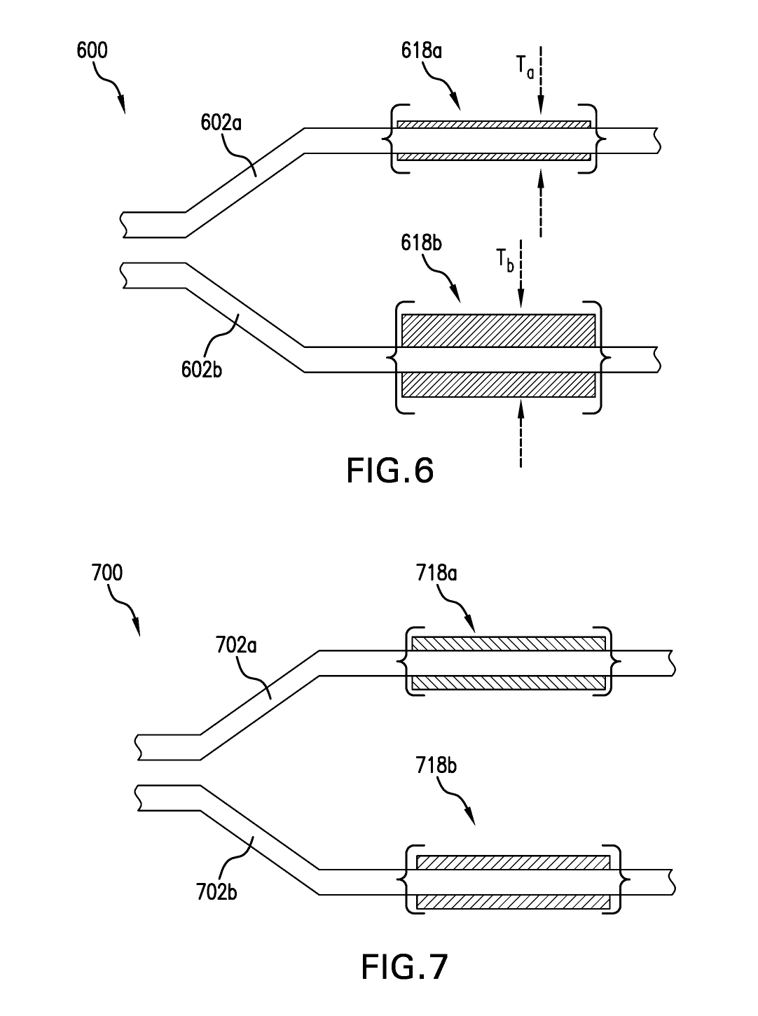

Turning now to FIG. 6, a schematic illustration of a portion of an optical fiber sensor system 600 in accordance with an embodiment of the present disclosure is shown. The optical fiber sensor system 600 can include a control system (not shown) similar to that shown and described above. FIG. 6 illustrates a system having a fiber optic cable 602a and a second fiber optic cable 602b. The first fiber optic cable 602a includes a first set of sensing elements 618a disposed thereon and the second fiber optic cable includes a second set of sensing element 618b disposed thereon. The first and second sets of sensing elements 618a, 618b can be formed from one or more sensing elements as described above. In this embodiment, the first set of sensing elements 618a includes one or more sensing elements having a first thickness Tₐ and the second set of sensing elements 618b includes one or more sensing elements having a second thickness T_{b} with the second thickness T_{b} being greater than the first thickness Tₐ. Similar to the embodiment of FIG. 4, the first and second sets of sensing elements 618a, 618b are formed from sensing elements that are composed of the same material, with only the thickness varying between the sets.

Turning now to FIG. 7, a schematic illustration of a portion of an optical fiber sensor system 700 in accordance with an embodiment of the present disclosure is shown. The optical fiber sensor system 700 can include a control system (not shown) similar to that shown and described above. FIG. 7 illustrates a system having a fiber optic cable 702a and a second fiber optic cable 702b. The first fiber optic cable 702a includes a first set of sensing elements 718a disposed thereon and the second fiber optic cable includes a second set of sensing element 718b disposed thereon. The first and second sets of sensing elements 618a, 618b can be formed from one or more sensing elements as described above. In this embodiment, the first set of sensing elements 718a includes one or more sensing elements being formed from a first material Mₐ (or first set of materials) and the second set of sensing elements 718b includes one or more sensing elements includes one or more sensing elements being formed from a second material M_{b} (or second set of materials). In some such embodiments, each optical fiber of a fiber optic cable (e.g., a bundle of fibers) can include a different set of sensing elements. The materials of the sensing elements (or sets of sensing elements) can be selected to have different corrosion rates, similar to that described above.

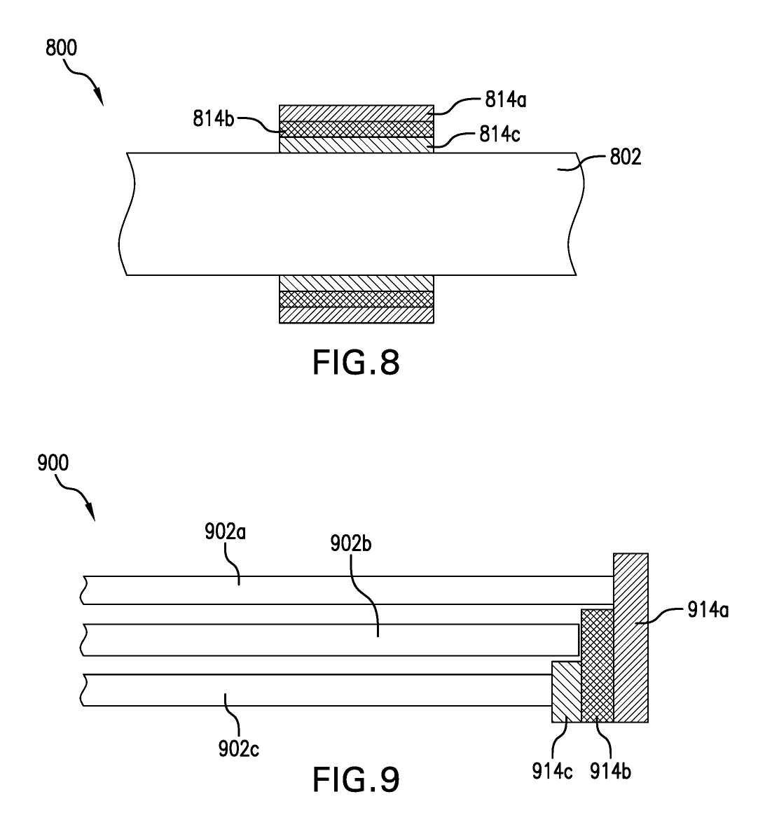

Turning now to FIG. 8, a schematic illustration of a portion of an optical fiber sensor system 800 in accordance with an embodiment of the present disclosure is shown. The optical fiber sensor system 800 can include a control system (not shown) similar to that shown and described above. FIG. 8 illustrates a fiber optic cable 802 having a first sensing element 814a, a second sensing element 814b, and a third sensing element 814c stacked at a single location along the length of the optical fiber cable 802. The first, second, and third sensing elements 814a, 814b, 814c of this embodiment are each formed from different materials. For example, the first sensing element 814a is formed from a first material Mₐ, the second sensing element 814b is formed from a second material M_{b}, and the third sensing element 814c is formed from a third material M_{c}. The materials Mₐ, M_{b}, M_{c} are selected to corrode at different rates from each other. In some embodiments, the first material Mₐ can corrode at a rate that is faster than the second material M_{b}, which in turn can be selected to corrode at a rate that is faster than the third material M_{c}. For example, the first material Mₐ can be selected to corrode at 50 Mils per year (mpy), the second material M_{b} can be selected to corrode at 10 mpy, and the third material can be selected to corrode at 0.5 mpy.

Turning now to FIG. 9, a schematic illustration of a portion of an optical fiber sensor system 900 in accordance with an embodiment of the present disclosure is shown. The optical fiber sensor system 900 can include a control system (not shown) similar to that shown and described above. FIG. 9 illustrates a first fiber optic cable 902a, a second fiber optic cable 902b, and a third fiber optic cable 902c. At an end of the fiber optic cables 902a, 902b, 902c are a number of end-on sensing elements. A first sensing element 914a, a second sensing element 914b, and a third sensing element 914c, as shown, are stacked at a single location at the end of the optical fiber cables 902a, 902b, 902c. The first, second, and third sensing elements 914a, 914b, 914c of this embodiment are each formed from different materials. For example, the first sensing element 914a is formed from a first material Ma, the second sensing element 914b is formed from a second material M_{b}, and the third sensing element 914c is formed from a third material M_{c}. The materials Mₐ, M_{b}, M_{c} are selected to corrode at different rates from each other. In this embodiment, the first fiber optic cable 902a has only the first sensing element 914a disposed thereon. In contrast, the second fiber optic cable 902b has a stack of sensing elements, including the first sensing element 914a, and the second sensing element 914b located at an end thereof. Further, still, the third fiber optic cable 902c has a stack of sensing elements, including the first sensing element 914a, the second sensing element 914b, and the third sensing element 914c located at an end thereof. Thus, the three different fiber optic cables can provide different lifetime corrosion rates and/or information.

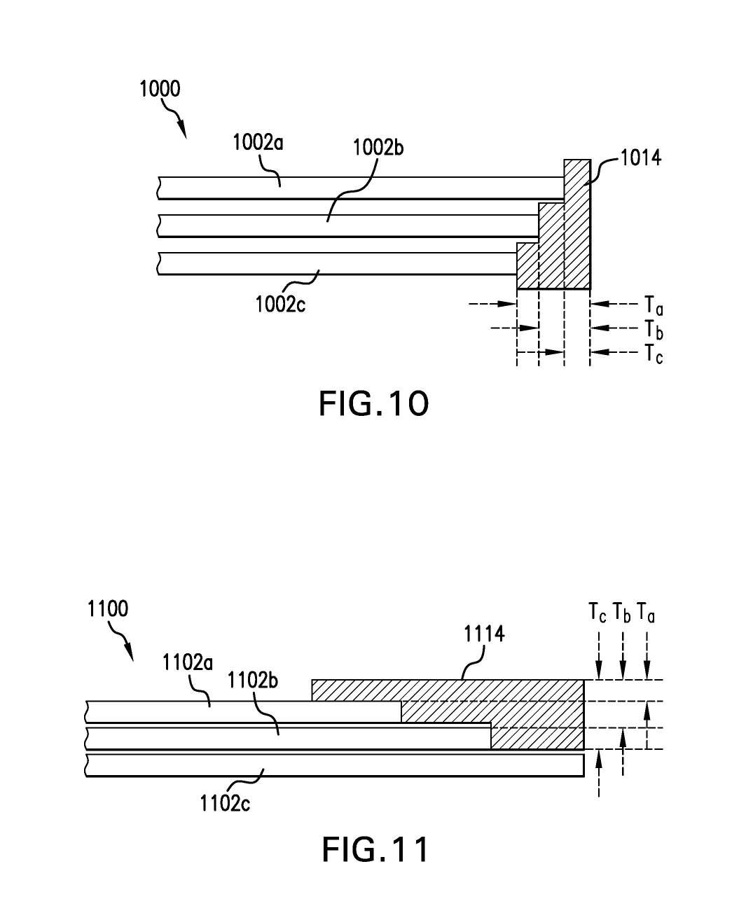

Turning now to FIG. 10, a schematic illustration of a portion of an optical fiber sensor system 1000 in accordance with an embodiment of the present disclosure is shown. The optical fiber sensor system 1000 can include a control system (not shown) similar to that shown and described above. FIG. 10 illustrates a first fiber optic cable 1002a, a second fiber optic cable 1002b, and a third fiber optic cable 1002c. At an end of the fiber optic cables 1002a, 1002b, 1002c is a single end-on sensing element 1014. The sensing element 1014 forms a “stacked” sensing element, with the sensing element having different thicknesses at the ends of the different optical fiber cables 1002a, 1002b, 1002c. For example, as shown, the sensing element 1014 has a first thickness Tₐ at the end of the first optical fiber cable 1002a, the sensing element 1014 has a second thickness T_{b} that is greater than the first thickness Tₐ at the end of the second optical fiber cable 1002b, and a third thickness T_{c} that is greater than the second thickness T_{b} at the end of the third optical fiber cable 1002c. The fiber optic cables 1002a, 1002b, 1002c having the end-on sensing element 1014 can provide lifetime corrosion rates and/or information.

Turning now to FIG. 11, a schematic illustration of a portion of an optical fiber sensor system 1100 in accordance with an embodiment of the present disclosure is shown. The optical fiber sensor system 1100 can include a control system (not shown) similar to that shown and described above. FIG. 11 illustrates a first fiber optic cable 1102a, a second fiber optic cable 1102b, and a third fiber optic cable 1102c. At an end of the fiber optic cables 1102a, 1102b, 1102c is a single end-on sensing element 1014. The sensing element 1014 forms a “stacked” sensing element, with the sensing element having different thicknesses at the ends and/or sides of the different optical fiber cables 1102a, 1102b, 1102c. For example, as shown, the sensing element 1114 has a first thickness Tₐ along the end of the first optical fiber cable 1102a, the sensing element 1114 has a second thickness Tb that is greater than the first thickness Tₐ along the end of the second optical fiber cable 1102b, and a third thickness T_{c} that is greater than the second thickness T_{b} along the end of the third optical fiber cable 1102c.

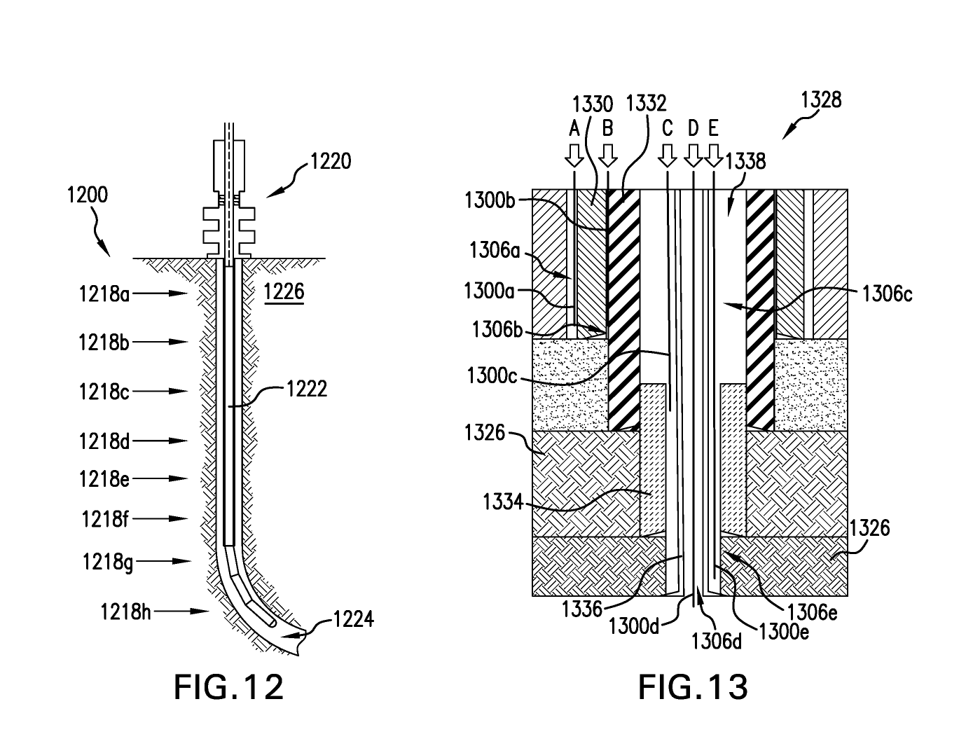

Turning now to FIG. 12, a schematic illustration of a system 1220 having an optical fiber sensor system 1200 for monitoring downhole environments and/or corrosion in accordance with an embodiment of the present disclosure is shown. The system 1220 includes a string 1222 located within a borehole 1224 that passes into and through a formation 1226. Disposed along the length of the string 1222 are a plurality of sets of sensing elements 1218a-1218h, wherein each set of sensing elements 1218a-1218h includes one or more sensing elements as shown and described herein. The disposition of the sets of sensing elements 1218a-1218h, in this embodiment, can enables a corrosion and/or chemical stratigraphy along the length of the borehole 1224. Accordingly, based on the corrosion of the sets of sensing elements 1218a-1218h (as analyzed by a control element, e.g., located at the surface) a map of different environmental conditions along the depth/length profile of the borehole 1224 can be obtained. Such analysis and/or mapping can include differences in concentrations of chemical compounds, severity of corrosion at different locations, distribution of types of corrosion, or other information associate with corrosion or other characteristics to which the sets of sensing elements 1218a-1218h may be sensitive. FIG. 12 is a subsurface schematic of the borehole 1224 and placement of the sets of sensing elements 1218a-1218h. As illustrated, embodiments provided herein enable multi-point detection across the depth/length of the borehole 1224. The illustrative arrows of the sets of sensing elements 1218a-1218h indicate example locations where fiber optic sensing elements are installed. In the system of FIG. 12, the distribution and/or deployment of the sets of sensing elements 1218a-1218h could be achieved by a single optical fiber having multiple sets of sensing elements thereon or the use of multiple fibers, with each fiber having one or more sets of sensing elements.

Turning now to FIG. 13, a subsurface illustration of a well with a downhole system 1328 located within a formation 1326 is shown. In this embodiment, the system 1328 includes multiple casings and production tubing disposed downhole and within the formation 1326. The system 1328, in this illustration, is a production system having a first casing 1330, a second casing 1332, a third casing 1334, and production tubing 1336 located therein. The system 1326 includes a plurality of fiber optic cables located in various positions to enable monitoring as described herein. The fiber optic cables may be similar to embodiments shown and described above. That is, the fiber optic cables can include one or more sensing elements or sets of sensing elements as described above.

A first optical fiber sensor system 1300a is shown with a fiber optic cable disposed in a first region of interest 1306a. The first region of interest 1306a, in this example, is a region located between the first casing 1330 and the formation 1326. A second optical fiber sensor system 1300b is shown with a fiber optic cable disposed in a second region of interest 1306b. The second region of interest 1306b, in this example, is a region located between the first casing 1330 and the second casing 1332. A third optical fiber sensor system 1300c is shown with a fiber optic cable disposed in a third region of interest 1306c. The third region of interest 1306c, in this example, is a region located in an annulus 1338 between the casings 1330, 1332, 1334 and the production tubing 1336. A fourth optical fiber sensor system 1300d is shown with a fiber optic cable disposed in a fourth region of interest 1306d. The fourth region of interest 1306d, in this example, is a region located within the production tubing 1336. A fifth optical fiber sensor system 1300d is shown with a fiber optic cable disposed in a fifth region of interest 1306e. The fifth region of interest 1306e, in this example, is a region located in contact with the formation 1326 and exterior to the production tubing 1336.

The arrangement shown in FIG. 13 enables monitoring in multiple locations and different environments or points/regions of interest. Although certain locations of possible deployment for fiber optics sensing elements inside the well are shown in FIG. 13, those of skill in the art will appreciate that other arrangements are possible without departing from the scope of the present disclosure. In some embodiments, the sensing elements of the various optical fiber sensor systems shown in FIG. 13 can be located at the ends of the fibers/fiber bundles to provide specific locational monitoring. In some embodiments, the sensing elements can be distributed along the length of the respective fibers/fiber bundles. Although shown in a vertical well, embodiments similar to that shown in FIG. 13 can be employed in horizontal wells, multilateral wells, or other well configurations, without departing from the scope of the present disclosure.

In accordance with embodiment provided herein, the optical fiber sensor system, and particularly, the sensing elements are selected to change or alter light properties of the fiber to which the sensing elements are applied. In some embodiments, the light in the fiber interacts with the material of the sending element, and/or in some embodiments, the material of the sending elements affects the light properties of fiber. In operation, changes in the material(s) of the sending elements as caused by changes in an environment and/or changes to the materials properties of the sensing elements (e.g., coating or thickness) cause a specific (and detectable) response Such response can be detected by a light sensor or photodetector that is optically connected to the fiber to which the sensing element is applied.

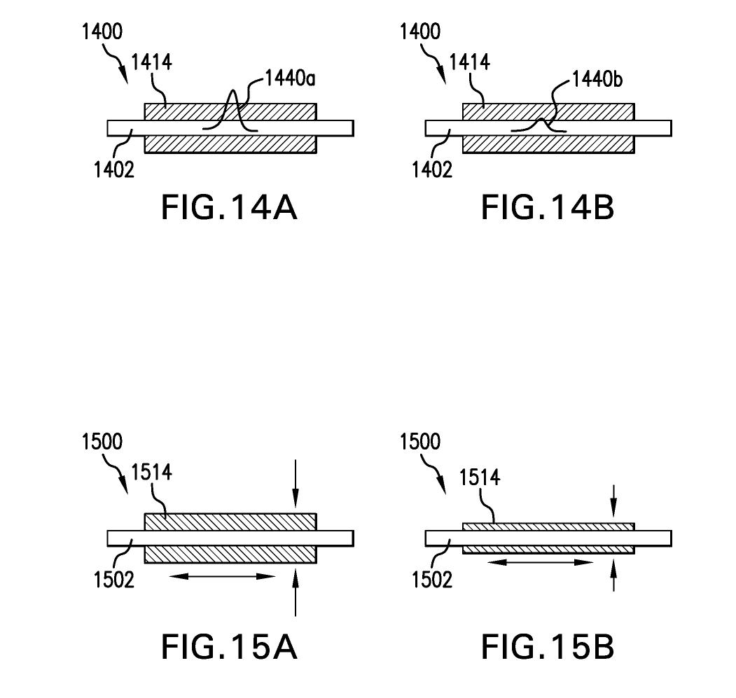

For example, turning now to FIGS. 14A-14B, schematic illustrations of how, a sensing element 1414 of an optical fiber sensor system 1400 can influence light traveling through a fiber optic cable 1402. The sensing element 1414 is an element that is, for example, a material that interacts with light and/or changes a light property of the fiber optic cable 14025. In this non-limiting example, FIG. 14A illustrates the sensing element 1414 having no changes or impact due to exposure to a monitored chemical and/or not subject to corrosion. As such, an evanescent wave 1440a interacting with the sensing element 1414 as shown in FIG. 14A has a first (e.g., large) amplitude, which is detectable by a photodetector (not shown) that is part of the optical fiber sensor system 1400. FIG. 14B illustrates the effect on the evanescent wave when the sensing element 1414 is subject to specific environments, and thus subject to a change in material property (e.g., change in composition, structure, coordination, complexation, etc.). As such, an evanescent wave 1440b interacting with the sensing element 1414 as shown in FIG. 14B has a second (e.g., small) amplitude. The difference in amplitudes shown in FIGS. 14A-14B are detectable by the photodetector to indicate corrosion at the location (e.g., region of interest) of the sensing element 1414.

In another example, turning now to FIGS. 15A-15B, schematic illustrations of a sensing element 1514 of an optical fiber sensor system 1500 is shown as affected by a region of interest (e.g., a corrosive environment). The sensing element 1514 is an element that is, for example, a material that interacts with light in an absorbance or reflectance spectroscopy manner. In this embodiment, the sensing element 1514 is formed of a material or coating that is wrapped around or applied to a fiber optic cable 1502 (e.g., forming a coated segment). The sensing element 1514 can be, in some embodiments, an engineered material coupon that is fixed to the fiber optic cable 1502 and causes string in coaxial and/or longitudinal directions, as indicated by the arrows show in FIGS. 15A-15B. The strain changes with the exposure to the environments due to corrosion and/or a change in material properties (e.g., change in material thickness, strength, etc.). As the changes due to the environment occur, the light properties of the fiber optic cable 1502 will change, and such light property changes are detectable by a photodetector of the optical fiber sensor system 1500.

Advantageously, embodiments provided herein enable downhole subsurface chemical intelligence, corrosion monitoring, and can provide data for artificial intelligence reservoir systems for corrosion and/or scale monitoring. Further, advantageously, embodiments provide a relatively simple solution for long distance monitoring of environments and/or regions of interest through the use of optical fibers (or bundles thereof) and monitoring impacts on one or more sensing elements that are arranged on the optical fibers.

### Embodiment 1

An optical fiber sensor system for monitoring environmental impacts in downhole systems, the optical fiber sensor system comprising: at least one optical fiber arranged along a downhole tool, the at least one optical fiber having a first end and a second end; a light source coupled to the first end of the at least one optical fiber and configured to project light into and along the at least one optical fiber; a photodetector coupled to the first end of the at least one optical fiber and configured to monitor light reflected along and through the at least one optical fiber; and at least one sensing element arranged on the at least one optical fiber, the at least one sensing element arranged to change a light property of the at least one optical fiber, wherein a change in the light property of the at least one optical fiber occurs based on exposure of the at least one sensing element to an environment of a region of interest.

### Embodiment 2

The optical fiber sensor system of any embodiment herein, wherein the change in the light property occurs due to at least one of corrosion of the at least one sensing element and chemical interaction with the at least one sensing element.

### Embodiment 3

The optical fiber sensor system of any embodiment herein, wherein the at least one sensing element is a plurality of sensing element arranged on the at least one optical fiber.

### Embodiment 4

The optical fiber sensor system of any embodiment herein, wherein at least two of the plurality of sensing elements are arranged at different positions along a length of the at least one optical fiber.

### Embodiment 5

The optical fiber sensor system of any embodiment herein, wherein at least two of the plurality of sensing elements are arranged at the same position along a length of the at least one optical fiber, wherein the at least two sensing elements are stacked.

### Embodiment 6

The optical fiber sensor system of any embodiment herein, wherein the at least one sensing element comprises a sacrificial coupon that is removable from the at least one optical fiber when exposed to the environment of the region of interest.

### Embodiment 7

The optical fiber sensor system of any embodiment herein, wherein the at least one sensing element is formed from a material that alters a light property of the at least one optical fiber based on exposure to the environment of the region of interest.

### Embodiment 8

The optical fiber sensor system of any embodiment herein, wherein the material is at least one of a metal, a metal oxide, a mixed metal/metal oxide, an oxide, a sulfide silicate, an aluminosilicate, glass, diamond, doped diamond, organic-inorganic composite material, a nano-material, and combinations thereof.

### Embodiment 9

The optical fiber sensor system of any embodiment herein, further comprising a control element arranged to control at least one of the light source and the photodetector to perform interrogation operations.

### Embodiment 10

The optical fiber sensor system of any embodiment herein, wherein the control element is configured to analyze optical signals received by the photodetector to determine a characteristic of the region of interest.

### Embodiment 11

The optical fiber sensor system of any embodiment herein, wherein the control element is configured to communicate with a remote system, wherein the remote system is configured to determine a characteristic of the region of interest based on information received from the control element.

### Embodiment 12

The optical fiber sensor system of any embodiment herein, wherein the at least one sensing element comprises an end-on sensing element configured at the second end of the at least one optical fiber.

### Embodiment 13

The optical fiber sensor system of any embodiment herein, wherein the at least one sensing element further comprises at least one sensing element disposed at a location between the first end and the second end of the at least one optical fiber.

### Embodiment 14

The optical fiber sensor system of any embodiment herein, wherein the at least one sensing element comprises a first sensing element and a second sensing element, wherein the first sensing element has a first thickness and the second sensing element has a second thickness that is different from the first thickness.

### Embodiment 15

The optical fiber sensor system of any embodiment herein, wherein the at least one sensing element comprises a first sensing element and a second sensing element, wherein the first sensing element is formed from a first material and the second sensing element is formed from a second material that is different from the first material.

### Embodiment 16

The optical fiber sensor system of any embodiment herein, wherein the at least one optical fiber comprises a first optical fiber and a second optical fiber, wherein a first sensing element of the at least one sensing elements is disposed on the first optical fiber and a second sensing element is disposed on the second optical fiber, wherein the second sensing element is at least one of a different thickness and a different material than the first sensing element.

### Embodiment 17

The optical fiber sensor system of any embodiment herein, wherein the at least one optical fiber comprises a first optical fiber and a second optical fiber, wherein a first sensing element of the at least one sensing elements is disposed on the second end of first optical fiber and a second sensing element is disposed on the second end of the second optical fiber, wherein the second sensing element is at least one of a different thickness and a different material than the first sensing element.

### Embodiment 18

The optical fiber sensor system of any embodiment herein, further comprising a string disposed within a borehole, wherein the at least one optical fiber is disposed along a length of the string.

### Embodiment 19

The optical fiber sensor system of any embodiment herein, wherein the at least one sensing element comprises a plurality of sensing elements disposed along the length of the string at a plurality if different positions.

### Embodiment 20

The optical fiber sensor system of any embodiment herein, wherein the at least one sensing element comprises a plurality of sensing elements form at least one set of sensing elements, wherein each set of sensing elements comprises at least two individual sensing elements.

In support of the teachings herein, various analysis components may be used including a digital and/or an analog system. For example, controllers, computer processing systems, and/or geo-steering systems as provided herein and/or used with embodiments described herein may include digital and/or analog systems. The systems may have components such as processors, storage media, memory, inputs, outputs, communications links (e.g., wired, wireless, optical, or other), user interfaces, software programs, signal processors (e.g., digital or analog) and other such components (e.g., such as resistors, capacitors, inductors, and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (e.g., ROMs, RAMs), optical (e.g., CD-ROMs), or magnetic (e.g., disks, hard drives), or any other type that when executed causes a computer to implement the methods and/or processes described herein. These instructions may provide for equipment operation, control, data collection, analysis and other functions deemed relevant by a system designer, owner, user, or other such personnel, in addition to the functions described in this disclosure. Processed data, such as a result of an implemented method, may be transmitted as a signal via a processor output interface to a signal receiving device. The signal receiving device may be a display monitor or printer for presenting the result to a user. Alternatively or in addition, the signal receiving device may be memory or a storage medium. It will be appreciated that storing the result in memory or the storage medium may transform the memory or storage medium into a new state (i.e., containing the result) from a prior state (i.e., not containing the result). Further, in some embodiments, an alert signal may be transmitted from the processor to a user interface if the result exceeds a threshold value.

Furthermore, various other components may be included and called upon for providing for aspects of the teachings herein. For example, a sensor, transmitter, receiver, transceiver, antenna, controller, optical unit, electrical unit, and/or electromechanical unit may be included in support of the various aspects discussed herein or in support of other functions beyond this disclosure.

The use of the terms “a,” “an,” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the present disclosure.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While embodiments described herein have been described with reference to various embodiments, it will be understood that various changes may be made and equivalents may be substituted for elements thereof without departing from the scope of the present disclosure. In addition, many modifications will be appreciated to adapt a particular instrument, situation, or material to the teachings of the present disclosure without departing from the scope thereof. Therefore, it is intended that the disclosure not be limited to the particular embodiments disclosed as the best mode contemplated for carrying the described features, but that the present disclosure will include all embodiments falling within the scope of the appended claims.

Accordingly, embodiments of the present disclosure are not to be seen as limited by the foregoing description, but are only limited by the scope of the appended claims.

What is claimed is:

1. An optical fiber sensor system for monitoring environmental impacts in downhole systems, the optical fiber sensor system comprising:
at least one optical fiber arranged along a downhole tool, the at least one optical fiber having a first end and a second end;
a light source coupled to the first end of the at least one optical fiber and configured to project light into and along the at least one optical fiber;
a photodetector coupled to the first end of the at least one optical fiber and configured to monitor light reflected along and through the at least one optical fiber; and
at least one sensing element arranged on the at least one optical fiber, the at least one sensing element arranged to change a light property of the at least one optical fiber, wherein a change in the light property of the at least one optical fiber occurs based on exposure of the at least one sensing element to an environment of a region of interest.

2. The optical fiber sensor system of claim 1, wherein the change in the light property occurs due to at least one of corrosion of the at least one sensing element and chemical interaction with the at least one sensing element.

3. The optical fiber sensor system of claim 1, wherein the at least one sensing element is a plurality of sensing element arranged on the at least one optical fiber.

4. The optical fiber sensor system of claim 3, wherein at least two of the plurality of sensing elements are arranged at different positions along a length of the at least one optical fiber.

5. The optical fiber sensor system of claim 3, wherein at least two of the plurality of sensing elements are arranged at the same position along a length of the at least one optical fiber, wherein the at least two sensing elements are stacked.

6. The optical fiber sensor system of claim 1, wherein the at least one sensing element comprises a sacrificial coupon that is removable from the at least one optical fiber when exposed to the environment of the region of interest.

7. The optical fiber sensor system of claim 1, wherein the at least one sensing element is formed from a material that alters a light property of the at least one optical fiber based on exposure to the environment of the region of interest.

8. The optical fiber sensor system of claim 7, wherein the material is at least one of a metal, a metal oxide, a mixed metal/metal oxide, an oxide, a sulfide silicate, an aluminosilicate, glass, diamond, doped diamond, organic-inorganic composite material, a nano-material, and combinations thereof.

9. The optical fiber sensor system of claim 1, further comprising a control element arranged to control at least one of the light source and the photodetector to perform interrogation operations.

10. The optical fiber sensor system of claim 9, wherein the control element is configured to analyze optical signals received by the photodetector to determine a characteristic of the region of interest.

11. The optical fiber sensor system of claim 9, wherein the control element is configured to communicate with a remote system, wherein the remote system is configured to determine a characteristic of the region of interest based on information received from the control element.

12. The optical fiber sensor system of claim 1, wherein the at least one sensing element comprises an end-on sensing element configured at the second end of the at least one optical fiber.

13. The optical fiber sensor system of claim 1, wherein the at least one sensing element further comprises at least one sensing element disposed at a location between the first end and the second end of the at least one optical fiber.

14. The optical fiber sensor system of claim 1, wherein the at least one sensing element comprises a first sensing element and a second sensing element, wherein the first sensing element has a first thickness and the second sensing element has a second thickness that is different from the first thickness.

15. The optical fiber sensor system of claim 1, wherein the at least one sensing element comprises a first sensing element and a second sensing element, wherein the first sensing element is formed from a first material and the second sensing element is formed from a second material that is different from the first material.

16. The optical fiber sensor system of claim 1, wherein the at least one optical fiber comprises a first optical fiber and a second optical fiber, wherein a first sensing element of the at least one sensing elements is disposed on the first optical fiber and a second sensing element is disposed on the second optical fiber, wherein the second sensing element is at least one of a different thickness and a different material than the first sensing element.

17. The optical fiber sensor system of claim 1, wherein the at least one optical fiber comprises a first optical fiber and a second optical fiber, wherein a first sensing element of the at least one sensing elements is disposed on the second end of first optical fiber and a second sensing element is disposed on the second end of the second optical fiber, wherein the second sensing element is at least one of a different thickness and a different material than the first sensing element.

18. The optical fiber sensor system of claim 1, further comprising a string disposed within a borehole, wherein the at least one optical fiber is disposed along a length of the string.

19. The optical fiber sensor system of claim 18, wherein the at least one sensing element comprises a plurality of sensing elements disposed along the length of the string at a plurality if different positions.

20. The optical fiber sensor system of claim 1, wherein the at least one sensing element comprises a plurality of sensing elements form at least one set of sensing elements, wherein each set of sensing elements comprises at least two individual sensing elements.
